(19) United States
(12) Patent Application Publication
(10) Pub. No.: US 2026/0361445 A1
(43) Pub. Date: Nov. 12, 2026

(54) METHODS FOR INDICATING THE SPECTRUM EXTENSION

(71) Applicant: Nokia Technologies Oy, Espoo (FI)

(72) Inventors: Oskari TERVO, Oulu (FI); Kari Juhani HOOLI, Oulu (FI); Esa Tapani TIIROLA, Oulu (FI); Marco MASO, Massy (FR); Nhat-Quang NHAN, Massy (FR); Arto LEHTI, Massy (FR)

(73) Assignee: Nokia Technologies Oy, Espoo (FI)

(21) Appl. No.: 19/129,890

(22) PCT Filed: Nov. 13, 2023
(86) PCT No.: PCT/IB2023/061455

§ 371 Date: May 14, 2025

Related U.S. Application Data
(60) Provisional application No. 63/425,118, filed on Nov. 14, 2022.

(51) Int. Cl. H04L 1/00; H04W 72/0453; H04W 72/1273

(52) U.S. Cl. CPC H04L 1/0003; H04L 1/0009; H04W 72/0453; H04W 72/1273

(57) ABSTRACT

An apparatus may be configured to: obtain a configuration, wherein the configuration comprises, at least, two or more extension factors; receive at least one indication of: at least one frequency domain resource allocation, or at least one modulation and coding scheme including at least one code rate; and determine at least one extension factor of the two or more extension factors based, at least partially, on the at least one indication. An apparatus may be configured to: transmit, to a user equipment, a configuration comprising two or more extension factors; and transmit, to the user equipment, at least one indication of: at least one frequency domain resource allocation, or at least one modulation and coding scheme including at least one code rate.

### TECHNICAL FIELD

The example and non-limiting embodiments relate generally to spectrum extension and, more particularly, to implicit signaling of spectrum extension.

### BACKGROUND

It is known, in network communications, to define multiple spectrum extension factors.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: obtain a configuration, wherein the configuration comprises, at least, two or more extension factors; receive at least one indication of: at least one frequency domain resource allocation, or at least one modulation and coding scheme including at least one code rate; and determine at least one extension factor of the two or more extension factors based, at least partially, on the at least one indication.

In accordance with one aspect, a method comprising: obtaining, with a user equipment, a configuration, wherein the configuration comprises, at least, two or more extension factors; receiving at least one indication of: at least one frequency domain resource allocation, or at least one modulation and coding scheme including at least one code rate; and determining at least one extension factor of the two or more extension factors based, at least partially, on the at least one indication.

In accordance with one aspect, an apparatus comprising means for performing: obtaining a configuration, wherein the configuration comprises, at least, two or more extension factors; receiving at least one indication: at least one frequency domain resource allocation, or at least one modulation and coding scheme including at least one code rate; and determining at least one extension factor of the two or more extension factors based, at least partially, on the at least one indication.

In accordance with one aspect, a non-transitory computer-readable medium comprising program instructions stored thereon for performing at least the following: causing obtaining of a configuration, wherein the configuration comprises, at least, two or more extension factors; causing receiving of at least one indication of: at least one frequency domain resource allocation, or at least one modulation and coding scheme including at least one code rate; and determining at least one extension factor of the two or more extension factors based, at least partially, on the at least one indication.

In accordance with one aspect, an apparatus comprising: at least one processor; and at least one memory storing instructions that, when executed by the at least one processor, cause the apparatus at least to: transmit, to a user equipment, a configuration comprising two or more extension factors; and transmit, to the user equipment, at least one indication of: at least one frequency domain resource allocation, or at least one modulation and coding scheme including at least one code rate.

In accordance with one aspect, a method comprising: transmitting, with a network node to a user equipment, a configuration comprising two or more extension factors; and transmitting, to the user equipment, at least one indication of: at least one frequency domain resource allocation, or at least one modulation and coding scheme including at least one code rate.

In accordance with one aspect, an apparatus comprising means for performing: transmitting, to a user equipment, a configuration comprising two or more extension factors; and transmitting, to the user equipment, at least one indication of: at least one frequency domain resource allocation, or at least one modulation and coding scheme including at least one code rate.

In accordance with one aspect, a non-transitory computer-readable medium comprising program instructions stored thereon for performing at least the following: causing transmitting, to a user equipment, of a configuration comprising two or more extension factors; and causing transmitting, to the user equipment, of at least one indication of: at least one frequency domain resource allocation, or at least one modulation and coding scheme including at least one code rate.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a chart illustrating features as described herein;

FIG. 5 is a chart illustrating features as described herein;

FIG. 6 is a flowchart illustrating steps as described herein; and

FIG. 7 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
6G sixth generation
ACLR adjacent channel leakage ratio
AMF access and mobility management function
BPSK binary phase shift keying
BWP bandwidth part
CDM code division multiplex
CM cubic metric
CP-OFDM cyclic prefix orthogonal frequency division multiplexing
CR code rate
CRAN cloud radio access network
CU central unit
DFT-s-OFDM discrete Fourier transform spread orthogonal frequency division multiplexing
DMRS demodulation reference signal
DU distributed unit
eNB (or eNodeB) evolved Node B (e.g., an LTE base station)

EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
EVM error vector magnitude
FDE frequency domain equalizer
FDSS frequency domain spectral shaping
FFT fast Fourier transform
FR1 frequency range 1
gNB (or gNodeB) base station for 5G/NR, i.e., a node providing NR user plane and control plane protocol terminations towards the UE, and connected via the NG interface to the 5GC
IAB integrated access and backhaul
IBE in-band emission
I/F interface
IFFT inverse fast Fourier transform
L1 layer 1
LTE long term evolution
MAC medium access control
MCS modulation and coding scheme
MME mobility management entity
MMSE minimum mean square error
MPR maximum power reduction
MT mobile termination
MU-MIMO multi-user multiple-input-multiple-output
ng or NG new generation
ng-eNB or NG-eNB new generation eNB
NR new radio
N/W or NW network
OCC orthogonal cover code
O-RAN open radio access network
PAPR peak to average power ratio
PDCP packet data convergence protocol
PHY physical layer
PRB physical resource block
PRT peak reduction tone
PSK phase shift keying
PUSCH physical uplink shared channel
QPSK quadrature phase shift keying
RA resource allocation
RAN radio access network
RB resource block
RE resource element
RF radio frequency
RIV resource indication value
RLC radio link control
RRC radio resource control
RRH remote radio head
RS reference signal
RU radio unit
Rx receiver
SDAP service data adaptation protocol
SE spectral efficiency
SEM spectral efficiency mask
SGW serving gateway
SMF session management function
TR tone reservation
Tx transmitter
UE user equipment (e.g., a wireless, typically mobile device)
UL uplink
UPF user plane function
VNR virtualized network function
ZC Zadoff-Chu

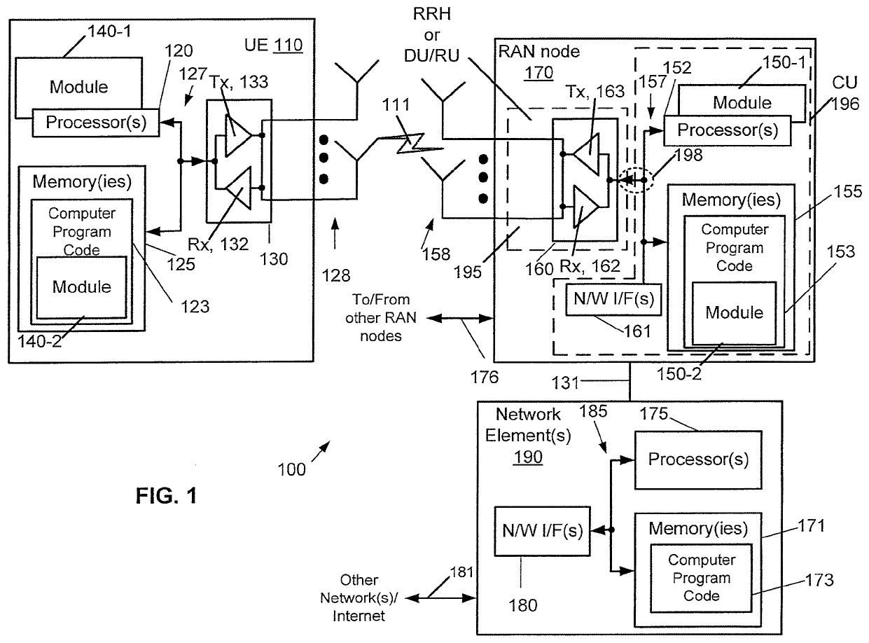

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR), and/or 5G-Advanced (i.e. NR Rel-18 and beyond) and/or 6G. In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

Additionally and/or alternatively, the functions of the UE 110 and the RAN node 170 may be performed by unit(s) configured to support integrated access and backhaul (IAB). For example, a mobile termination (MT) part of IAB node may perform UE functionalities, while a distributed unit (DU) part of IAB node may perform DU functionalities.

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein generally relate to coverage. Good coverage is critical for cellular networks; coverage enhancements are considered in NR Rel-18. Features as described herein may relate to coverage enhancements that may have the technical effect of enabling higher UE transmit powers by reducing a signal's peak-to-average power ratio (PAPR). In particular, features as described herein may relate to spectrum extension (SE) for frequency domain spectrum shaping (FDSS) and tone reservation (TR), and more specifically to efficient control of the extension.

Features as described herein may relate to 5G NR waveforms. Modulated symbols and/or reference signals are converted to a waveform, which is a baseband signal, before being mixed to radio frequency (RF) and transmitted over the air-interface. In 5G NR, two waveforms have been specified, including: cyclic prefix orthogonal frequency division multiplexing (CP-OFDM), which is applicable to both uplink and downlink; and discrete Fourier transform spread orthogonal frequency division multiplexing (DFT-s-OFDM), which is applicable to only uplink. However, while example embodiments of the present disclosure are discussed with respect to the UL, this is not limiting; example embodiments of the present disclosure may be applicable to a DL scenario.

DFT-s-OFDM only supports a single transmission layer (rank=1) per user, whereas CP-OFDM can support more than one layer (rank≥1). This means that CP-OFDM can offer a higher throughput and capacity than DFT-s-OFDM. In contrast, DFT-s-OFDM has a lower peak-to-average power ratio (PAPR) than its counterpart, which allows DFT-s-OFDM to be used with a higher transmit power, and thus offer better coverage. For example, in NR (e.g. power class 3), DFT-s-OFDM has 1.5-2 dB smaller maximum power reduction than CP-OFDM with QPSK modulation (the actual value depends on the resource block allocation). This translates to 1.5-2 dB higher guaranteed maximum Tx power from UE.

DFT-s-OFDM is generated by adding a transform precoding block before the processing blocks used for generating CP-OFDM. In fact, the transform precoding block is a fast Fourier transform (FFT) block that converts a time domain signal into a frequency domain signal.

Features as described herein may relate to frequency domain spectrum shaping (FDSS) with and without spectrum extension. Although DFT-s-OFDM already offers a lower PAPR compared to its CP-OFDM counterpart, 5G NR Release 15 (Rel-15) also introduced a frequency domain spectrum shaping function (FDSS), which was used to further reduce the PAPR and/or lower Cubic Metric (CM) for pi/2-BPSK modulation. This entails further lower Maximum Power Reduction (MPR), and hence higher maximum transmission power for coverage enhancement.

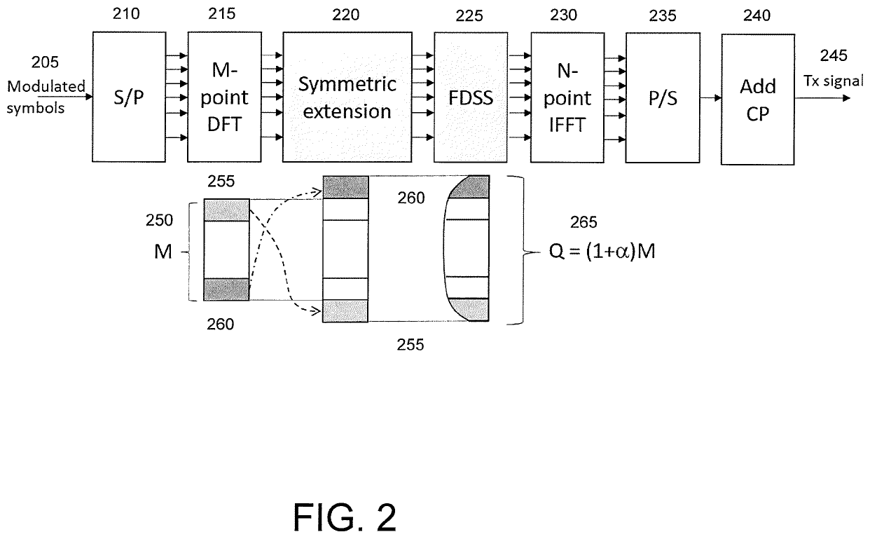

Spectral shaping may be applied with or without spectral extension. Currently NR Rel_18 is considering to introduce FDSS function with spectral extension. The block diagram of NR UL transmitter with frequency domain spectral shaping and spectrum extension chain is illustrated in FIG. 2. Modulated symbols (205) may be input to a S/P (210). The output of the S/P (210) may be provided to an M-point discrete Fourier transform (DFT) (215). The output of the M-point DFT (215) may be provided to a symmetric extension module (220). It may be noted that this is not limiting; the extension and/or extension module may alternatively be a cyclic extension and/or extension module, or a cyclic shift plus symmetric extension and/or extension module. In the present disclosure, a person of ordinary skill in the art would understand that the mention of one type of extension and/or extension module may be replaced with another type of extension and/or extension module.

The output of the symmetric extension module (220) may be provided to a FDSS (225). In spectral shaping, the transition band bins may be weighted by the FDSS function before mapping to the IFFT input. It may be noted that transition band bins may be mapped to new positions (i.e. 255, 260). The FDSS with spectrum extension has the additional extension block, which results in excess bands (see R1-050702, “DFT-Spread OFDM with Pulse Shaping Filter in Frequency Domain in Evolved UTRA Uplink”, NTT DoComo, NEC, Sharp).

The output of the FDSS (225) may be provided to an N-point inverse fast Fourier transform (IFFT) (230). The output of the N-point IFFT (230) may be provided to a P/S (235). The output of the P/S (235) may be provided to a module to add a cyclic prefix (240) to generate the Tx signal (245).

In FIG. 2, the spectrum extension is depicted with the following parameters. Inband size refers to the occupied resource elements (RE) after the DFT-block (215): M (250). Excess band size refers to the amount of REs for spectrum extension (i.e. Q-M). Total allocation size (i.e. Inband size+Excess band size) refers to the occupied REs after the symmetric extension block (220): Q (265). The amount of extension may be expressed by means of extension factor α: α=((Q−M))/Q (i.e. Excess band size/Total allocation size).

The spectrum extension may provide several advantages. Firstly, it may reduce the PAPR since the effective pulses have larger time separation. Secondly, it may reduce the inter-symbol interference, which is added when FDSS is introduced. Finally, since the excess band is also data, it may or may not be used by a gNB receiver. In case it is used, it may provide further frequency diversity.

The shaping function without spectrum extension is a tradeoff between demodulation performance and the Tx power gain (see, e.g., R1-1709002, On spectrum shaping for uplink Pi/2 BPSK with DFT-S-OFDM, Nokia, Alcatel-Lucent Shanghai Bell; R4-1714191, Further Link Results for p/2 BPSK DFT-S-OFDM Waveform with Spectrum Shaping and MMSE Receiver; R1-1705060, Performance evaluation for pi/2 BPSK with FDSS; R4-1710213, On the detection performance of pi/2-BPSK DFT-s-OFDM with transparent shaping). Meanwhile, shaping with spectrum extension is tradeoff between spectral efficiency and Tx power gain (see, e.g., R1-050702, “DFT-Spread OFDM with Pulse Shaping Filter in Frequency Domain in Evolved UTRA Uplink”, NTT DoComo, NEC, Sharp). In Rel-15, FDSS is applied for DFT-s-OFDM without spectrum extension, and it is used only with pi/2-BPSK modulation. In the Rel-17 study item for coverage enhancement, it was pointed out that the gain, by applying FDSS to higher order modulation techniques (e.g., QPSK), is lower than the gain when applying FDSS to pi/2-BPSK (see R1-2008703, Discussion on approaches and solutions for NR PUSCH coverage enhancement, Nokia, Nokia Shanghai Bell). Given that Rel-18 would like to thoroughly improve the UL coverage, enhancements for other higher order modulation techniques (esp. QPSK) should also be taken into account; FDSS with spectrum extension is one candidate solution.

Features as described herein may relate to tone reservation (TR). Tone reservation is another technique for PAPR reduction. With this technique, signals in a subset of available sub-carriers may be carefully designed to cancel the peaks in the (original) waveform and, hence, reduce the PAPR of the waveform. These subcarriers are referred to as peak reduction tones (PRTs) (a.k.a. Peak Cancellation Signal). To preserve the error vector magnitude (EVM), there is no overlap between the PRTs and the subcarriers used for transmitting the data. Tone reservation was proposed during the Rel-17 study item for coverage enhancement as one candidate solution (see R1-2008626, Potential coverage enhancement techniques for PUSCH, Qualcomm), and is also being considered in Rel-18 as one PAPR reduction technique. The excess band part (or any REs in total allocation including excess band) may be used for PRTs.

Features as described herein may relate to maximum power reduction (MPR) and inner, outer, and edge resource block (RB) allocation. A UE may reduce its maximum output power depending, for example, on the modulation order as well as on the RB allocation. The amount of max output power reduction is limited, among others, by standardized maximum power reduction (MPR) values. As an example of MPR values, the MPR table (TABLE 1) for power class 3 UE on frequency range 1 is shown below (see TS38.101-1, “NR; User Equipment (UE) radio transmission and reception; Part 1: Range 1 Standalone”).

TABLE 1

MPR (dB)

| | Edge RB | Outer RB | Inner RB |
|---|---|---|---|
| Modulation | allocations | allocations | allocations |
| DFT-s-OFDM PI/2 | ≤3.5¹ | ≤1.2¹ | ≤0.2¹ |
| BPSK | 0.5² | 0.5² | 0² |

| | | |
|---|---|---|
| DFT-s-OFDM | ≤1 | 0 |

QPSK

| | | |
|---|---|---|
| DFT-s-OFDM 16 | ≤2 | ≤1 |

QAM

| | |
|---|---|
| DFT-s-OFDM 64 | ≤2.5 |

QAM

| | |
|---|---|
| DFT-s-OFDM 256 | 4.5 |

QAM

| | | |
|---|---|---|
| CP-OFDM QPSK | ≤3 | ≤1.5 |
| CP-OFDM 16 QAM | ≤3 | ≤2 |

| | |
|---|---|
| CP-OFDM 64 QAM | ≤3.5 |
| CP-OFDM 256 | ≤6.5 |

QAM

NOTE 1:
Applicable for UE operating in TDD mode with PI/2 PBSK modulation and UE indicates support for UE capability [powerBoosting-pi2BPSK] and if the IE powerBoostPi2BPSK is set to 1 and 40% or less slots in radio frame are used for UL transmission for bands n40, n41, n77, n78 and n79. The reference power of 0 dB MPR is 26 dBm.
NOTE 2:
Applicable for UE operating in FDD mode, or in TDD mode in bands other than n40, n41, n77, n78 and n79 and if the IE powerBoostPi2BPSK is set to 0 and if more than 40% of slots in radio frame are used for UL transmission for bands n40, n41, n77, n78 and n79.

It may be noted that separate MPR values are given for edge, outer, and inner RB allocations. In TS38.101-1, those values are defined as follows:
“ . . . . Where the following parameters are defined to specify valid RB allocation ranges for Outer and Inner RB allocations:
NRB is the maximum number of RBs for a given Channel bandwidth and sub-carrier spacing defined in Table 5.3.2-1. RB_{Start,Low}=max(1, floor(L_{CRB}/2))
where max( ) indicates the largest value of all arguments and floor (x) is the greatest integer less than or equal to x.

RB_{Start,High}=NRB−RB_{Start,Low}−L_{CRB}
The RB allocation is an Inner RB allocation if the following conditions are met

RB_{Start,Low}≤RB_{Start}≤RB_{Start,High}, and

L_{CRB}≤ceil(N_{RB}/2)
where ceil(x) is the smallest integer greater than or equal to x.
An Edge RB allocation is one for which the RB's are allocated at the lowermost or uppermost edge of the channel with LCRB≤2 RB's.
The RB allocation is an Outer RB allocation for all other allocations which are not an Inner RB allocation or Edge RB allocation . . . ”

Features as described herein may relate to spectrum flatness requirements for FDSS with spectrum extension. The current NR specification supports FDSS without spectral extension for pi/2 BPSK. The exact FDSS function is not defined in the standard, but the performance requirements are specified to define the boundary conditions to the implementation. Thus, the standard allows for vendors to do their own implementation and performance optimizations, and the system performance is tried to be guaranteed by means of minimum requirements related to spectral flatness, in-band/out-of-band emission, and EVM.

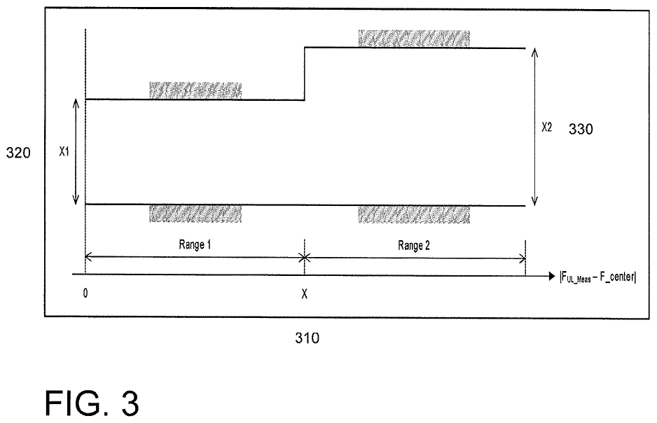

In example embodiments of the present disclosure, EVM equalizer flatness may be used for setting the UE Tx spectral flatness requirements for pi/2-BPSK with spectral/spectrum shaping. The peak-to-peak variation of the EVM equalizer coefficients contained within the frequency range of the uplink allocation may not be allowed to exceed the limits defined in the NR specification(s). The spectral flatness requirement when spectral shaping is used for pi/2-BPSK (without spectral extension) may be defined for two frequency ranges that divide the allocation in two equal-size parts. Referring now to FIG. 3, illustrated is an example of the limits for EVM equalizer spectral flatness requirements with the maximum allowed variation, with related parameters X1 (320) and X2 (330) (see TS 38.101). In TS 38.101-1, the following value are given for the parameters X (310), X1 (320), and X2 (330) used in setting the minimum UE Tx spectrum flatness requirements for pi/2-BSPK spectrum shaping waveforms: X1=−6 dB, X2=−14 dB and X, in MHz, is equal to 25% of the bandwidth of the physical resource block (PRB) allocation.

In an example embodiment, when considering the Rel-18 scenario, spectral flatness requirements defined for pi/2 BPSK (in Rel-17) may need to be updated to cover also the quadrature phase shift keying (QPSK) scenario with shaping and extension. In one example embodiment, the current ranges defined for pi/2 BPSK may be applied as such for the total allocation (Inband+Excess band). In another example embodiment, the first and the second range may define the EVM equalizer spectral flatness requirements similarly as in Rel-17 (i.e. only for inband). This may be made by means of three parameters similar to X, X1, and X2. In addition, a third range may be introduced corresponding to EVM equalizer spectral flatness requirements for the excess band. This may be defined by means of a fourth parameter, X3. The third range may have more relaxed requirements due to the fact that the excess band is not primarily carrying the (non-redundant) information, but rather may be a partial copy of some of the in-band subcarriers (frequency-domain REs), which may or may not be used at the gNB receiver.

Features as described herein may relate to a resource indication value in the context of resource allocation (RA) type 1. The resource indication value (RIV) relates to frequency domain resource allocation type 1, which is the only RA type which can be used with DFT-s-OFDM. In this type, the resource is allocated to one or more consecutive RBs. In this context, the RIV is a value indicating RB_Start and Number of Consecutive RBs within a specific bandwidth part, i.e., LRBs, and is calculated as follows:

$$if ( {L}_{RBs} - 1 ) \leq ⌊ {N}_{BWP}^{size} / 2 ⌋ then$$

$$RIV = {N}_{BWP}^{size} ( {L}_{RBs} - 1 ) + {RB}_{start}$$

$$else$$

$$RIV = {N}_{BWP}^{size} ( {N}_{BWP}^{size} - {L}_{RBs} + 1 ) + ( {N}_{BWP}^{size} - 1 - {RB}_{start} )$$

The following agreement has been made in RAN1 #110b-e:
“ . . . The following design aspects of frequency domain spectrum shaping with spectrum extension (FDSS-SE), are considered for studying MPR/PAR reduction enhancements in Rel-18:
   Spectrum extension size is expressed in integer units of RBs.
   Both DMRS and data symbols undergo spectrum shaping
   FFS:
      Which extensions factor(s) to consider, where extension factor (a) is given by spectrum extension size/Total allocation size.
      Impact of shaping filter on FDSS-SE performance
      How to extend DMRS sequence to spectrum extensions, based on either the existing ZC-sequence DMRS or low-PAPR DMRS for PUSCH (FG 16-6c)
      How extension size is determined . . . ”

Example embodiments of the present disclosure may relate to how the extension factor(s) are determined, where extension factor (a) is given by spectrum extension size/total allocation size.

Potential extension factor(s) have been investigated via simulations, where the ‘optimal’ extension factor may depend on many aspects, such as allocation size and/or allocation location. Thus, it may be expected that multiple extension factors may have to be supported based on many different factors, and efficient signaling may be needed to adapt to different cases, without introducing extra DCI overhead (e.g. implicit signaling). Furthermore, the case without extension may be considered as on extension factor, □=0. Example embodiments of the present disclosure may have the technical effect of providing efficient signaling for multiple extension factors.

Features as described herein may relate to signaling method(s) for multiple extension factors. Multiple extension factors may be defined/supported by NR specification(s). RRC may be used to configure one or more extension factors. In one signaling method, only RRC may be used to configure an extension factor. DCI may select between “No_ext” and “Ext”. In another signaling method, RRC and DCI may be used. For example, RRC may be used to configure more than one extension factor. For example, RRC may configure the valid extension sizes (e.g. a, b, c). The number of valid extension sizes may define the number of needed indicator bits in DCI. For example, DCI may contain, for example, 2 indicator bits (four states). The gNB may select one out of four states for the current Tx: 0: no extension; 1: extension factor a; 2: extension factor b; or 3: extension factor c.

The above signaling assumes that multiple extension factors may be configured by RRC signaling, while the extensions may be indicated in DCI, causing extra overhead of 1 bit if one extension factor is supported, and at least two bits for multiple extension factors. This may complicate acceptance of this method for 3GPP NR, since arguments related to its inefficiency could be brought. More efficient indication of the extension sizes may be needed in this context to maximize probability of acceptance in 3GPP.

Example embodiments of the present disclosure may have the technical effect of providing efficient dynamic signaling of spectrum extension without introducing extra overhead in DCI, which may be considered as implicit signaling. Example embodiments of the present disclosure may also have the technical effect of providing a way to support multiple extension factors on top of explicit signaling. In an example embodiment, explicit indication (such as MAC CE or one bit in DCI) may indicate extension on/off.

In an example embodiment, a UE may be configured with at least a first extension factor and one or more further extension factors. For example, the configuration may be done via RRC signaling by a gNB. In an example embodiment, extension factors may be tied to spectrum flatness requirements, such that different extension factors may be tied to different spectrum flatness requirements. Based on this, the gNB may drive the UE's FDSS filter selection implicitly, according to the configured and indicated extensions factor. This may allow the gNB to select a more suitable Tx filter for decoding the received signal, and may optimize the net gain (=Tx gain−Rx loss) for FDSS with spectrum extension.

In an example, a UE may be configured with a first extension factor (e.g. α=0.25), which may act as the default extension factor, and a second extension factor (e.g. α=0.125 or α=0.375). The factors may be defined based on a spectrum flatness requirement. The default extension factor (α=0.25) may follow current spectrum flatness requirements defined for pi/2 BPSK (with max attenuation −6 dB for Range1 and −14 for Range2, as shown in FIG. 3). In an example embodiment, this fixed value may be used. The second extension factor (e.g. α=0.125) may operate according to the second spectrum flatness requirements supporting only less aggressive filters (with max attenuation −3 dB for Range1 and −7 for Range2). The actual parameters values (X1, X2, X) may vary from scenario to scenario.

In an example embodiment, a UE may be configured with one or more zones/ranges of the allocation size where the rules to apply the first extension factor or other extension factors may be applicable. For example, zones/ranges may be indicated by suitable L_RBmin and L_RBmax values, which may provide a minimum allocation size and maximum allocation size, respectively. When more than one zone/range is configured, multiple L_RBmin and L_RBmax values may be configured (i.e., one per zone). For example, where L_RBmin=10 and L_RBmax=100, if the indicated allocation size is between these values (i.e. within that range of the allocation), then the UE may follow the implicit extension size indications. In other allocations, there may be no extension factor applicable, or some other fixed extension. In another example, the range of allocation sizes may simply mean that, up to allocation size L_RBthreshold, the UE may use extension 1 and, above the threshold, the UE may use extension 2. Alternatively, there may be multiple threshold values.

In an example embodiment, the (configured) UE may receive a scheduling DCI (or other signaling) including at least one of frequency domain resource allocation, and/or code rate and/or modulation and coding scheme (MCS). A MCS index may involve both modulation and code rate. For example, the MCS may include at least one code rate. For example, the code rate may be determined based on the MCS. In an example embodiment, this scheduling DCI may also include a separate bit indication for extension on/off. This may provide partially implicit signaling. Alternatively, extension on/off indication may be handled as an extension factor (α=0). This may provide fully implicit signaling; for example, the scheduling DCI may not include a bit for the extension, and extension determination may instead be performed based on at least one of FDRA and/or MCS/CR, as more fully described below. In an example embodiment, the DCI may be used by the UE to select a spectrum extension for a (current) transmission. In the present disclosure, a “current transmission” may be considered the transmission triggered by the (scheduling) DCI.

In an example embodiment, the UE may follow implicit signaling rules to choose one extension factor from among multiple extension factors that are only applicable for specific zones for code rate and/or for specific allocations. For example, the UE may consider at least one extension factor applicable for a specific code rate zone, as well as at least one extension factor applicable to a specific allocation. For example, an extension factor may be dependent upon a code rate. However, this is not limiting; extension factors dependent on other variable(s) may be possible, beyond QPSK.

For example, if the indicated code rate is between a minimum code rate and a maximum code rate (i.e. within a range of the code), then the UE may follow the implicit extension size indications. In other code rate ranges, there may be no extension factor applicable, or some other fixed extension. In another example, the range of code rate may simply mean that, up to a code rate value threshold, the UE may use extension 1 and, above the threshold, the UE may use extension 2. Alternatively, there may be multiple threshold values.

In an example embodiment, the UE may determine whether to apply the first extension factor or any of the other extension factor(s) based on at least one of the frequency domain resource allocation, and/or the code rate/MCS (optionally, also further based on extension on/off indication). For example, the determination may be performed based on the RIV value (or, equivalently, RB_start, BWP size, and/or allocation size).

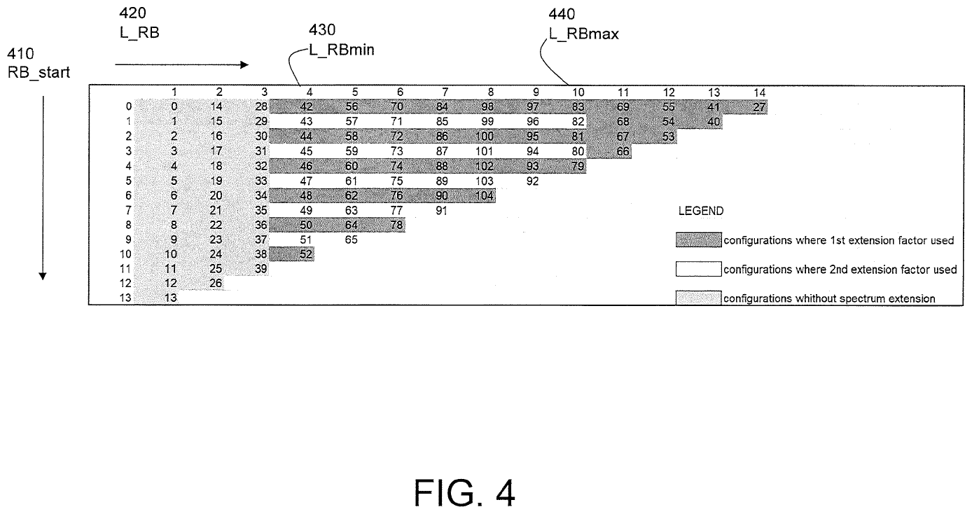

In an example embodiment, two extension factors may be configured to the UE. If the RIV corresponds to an even RB_start (e.g. an even starting resource block), a first extension factor may be applicable, while if RIV corresponds to an odd RB_start (e.g. an odd starting resource block), a second extension factor may be applicable (see, e.g., the example of FIG. 4). For example, if the UE receives a DCI including RIV=i, which may correspond to RB_start=0 (i.e., even), then a first extension factor (e.g. 0.25) may apply, while if the UE receives a DCI including RIV=i+1, which may correspond to RB_start=1 (odd), a second extension factor (e.g. 0.125) may apply. In this nonlimiting example, there may be a 25% extension for RIV=i, and a 12.5% extension for RIV=i+1.

In another example embodiment, N extension factors may be configured to the UE, numbered from 1 to N. The nth extension factor may apply if RIV corresponds to an RB_start such that mod (RBₛₜₐᵣₜ, N)+1=n. It may be noted that this expression may only be valid for a specific numbering of the extension factors. For example, if the factors are numbered from 1 to N, then the nth extension factor may indeed apply if RIV corresponds to an RB_start such that mod (RB_start,N)+1=n. However, if the N extension factors are numbered from 0 to N−1, then the nth extension factor may apply if RIV corresponds to an RB_start such that mod (RB_start,N)=n. A person of ordinary skill in the art would understand that there are various options for associating an extension factor to a RIV.

It may be noted that, if the N extension factors are numbered from 0 to N−1, the nth extension factor may apply if RIV corresponds to an RB_start such that mod(RBₛₜₐᵣₜ, N)=n. For example, if the UE receives a DCI including RIV=i, the first extension factor may apply when mod(i,N)=0, and the second extension factor may apply when mod (i,N)=1, and so on.

In another example embodiment, if RIV corresponds to a specific allocation region, a specific extension factor may apply. A specific allocation region may be defined by the couple of values RB_start and L_{RBs}. In other words, RB regions may be configured via RRC by means of RB_start_low (or RB_start_high) and/or allocation size. RB_start_low may indicate the minimum starting RB of the allocation.

In another example embodiment, the RIV (or, alternatively, allocation size L_{RBs}) region may specify the applicable extension factor implicitly, depending on one or more thresholds tied/related/associated to (e.g. two or more) configured extension factors. For example, extension factors may depend on allocation size (and/or location). The thresholds may be defined by the specification(s), or it may be configured via RRC signaling. N−1 thresholds may be specified/configured for N extension factors. For example, let γᵢ be the ith threshold, with i∈[0, N−2]. For RIV (or L_{RBs})≤γ₀, a first extension factor may apply. If N=2, for RIV (or L_{RBs})>γ₀ a second extension factor may apply. If N>2, for γ₁>RIV (or L_{RBs})>γ₀ a second extension factor may apply, for γ₂>RIV (or L_{RBs})>γ₁ a third extension factor may apply, and so on. In another example, if the RIV is greater than a first threshold, a first extension factor may apply, while if the RIV is less than or equal to the first threshold, a second, different extension factor may apply. These examples are not limiting; other associations between RIV and threshold values may be used.

In another example embodiment, the determined extension factor may depend on allocation size such that extension size or size of one side of extension for symmetric allocation is, for example, an integer multiple of PRBs or integer multiple of half of PRB.

In another example embodiment, the relationship between the extension factor and allocation size and/or RB_start (for example, a dependency) may be configured using a bitmap conveyed via RRC signaling.

In another example embodiment, if two extension factors are configured, and using the first or the second extension factor results in a PRB allocation outside the current bandwidth part (BWP), the smallest extension factor, of the first and the second extension factor, may apply. The UE may bypass any dynamic signaling from the NW related to which extension factor to use, in favor of an extension factor determined according to an example embodiment.

In another example embodiment, if the determined extension from the first and the second extension factor results in the PRB allocation having some PRBs outside the current BWP, the determined extension may be truncated to the edge of the BWP.

In another example embodiment, if upon decoding the RIV, the UE assesses that no configured extension factor results in a PRB allocation such that all PRBs of the allocation are inside the current BWP, this may be interpreted by the UE as a configuration/indication to disable the extensions for this FDSS transmission.

In an example embodiment, the UE may be configured with one or more zones of the code rate where the rules to apply the two or more extension factors are applicable. In an example embodiment, different extension factors may be applicable to different zones of code rate (e.g. a first extension factor may be applicable to a first zone of code rate, a second extension factor may be applicable to a second zone of code rate, etc.). In an example embodiment, a first zone of code rate may not overlap with a second zone of code rate (i.e. non-overlapping). A maximum code rate may be configured to provide an upper limit to the rules. In one example embodiment, an indicated code rate larger than the maximum configured code rate may correspond to the determination of extension factor α=0. For example, the UE may determine an extension factor α=0 in response to a specific signaling which may be considered an error case (e.g. implicit signaling).

In a further example embodiment, a UE may be configured with multiple zones of the code rates. Each code rate zone may have the two or more extension factors configured separately. When the UE receives PUSCH allocation with a code rate, the extension factor values configured for the corresponding code rate zone may be used when determining the extension factor to apply (according to the embodiments above using the RIV value (or RB_start, BWP size and/or allocation size)). A zone may be indicated by a minimum code rate and maximum code rate. A technical effect of example embodiments of the present disclosure may be to allow use of smaller extension factors for higher code rates.

In an example embodiment, a combination of code rate size and allocation size may be used to determine the extension factor. For example, one code rate may be associated with a first extension if the allocation size is X, but the same code rate may be associated with a second extension factor if the allocation size is Y.

In an example embodiment, both the RB allocation (or RIV) and the MCS/CR may contribute to the determination of one of the one or more configured extension factors.

In an example embodiment, there may be three configured extension factors. The first extension factor may be applicable if LRBs<thresholdRB and CR<thresholdCR. The second extension factor may be applicable if LRBs≥thresholdRB and CR<thresholdCR. The third extension factor may be applicable if CR≥threshold 2.

In an example embodiment, a UE may apply the determined extension factor for the PUSCH.

Referring now to FIG. 4, illustrated is an example of RIV-based extension factor determination based on even/odd values. In the present example, only two extension factors may be configured. However, this example is not limiting; any number of extension factors may be configured. For example, three or more configured extension factors may be devised following the same principles, (e.g., as many colors as number of configured extension factor are used (plus one, i.e., the without spectrum extension case).

In the example of FIG. 4, RIV may be used as an implicit indicator; the configuration provided by the UE is depicted using a table for illustrative purposes. In the present example, the BWP size is 14. The first column (410) shows starting PRB. The first row (420) shows allocation size (note that allocations not applicable to DFT-s-OFDM are included for simplicity, even though they are not to be considered in practice. This does not change the principle illustrated in the table.). One allocation zone to apply multiple extension factor values based on the rules is configured, and its boundaries are set as L_RBmin=4 (430), L_RBmax=10 (440). The light gray area is mapped to configurations without spectrum extension. The dark gray area is mapped to configurations where the first extension factor is used. The white area is mapped to configurations where the second extension factor is used. RIVs resulting in even RB_start within the zone (430 to 440) or, alternatively, for which mod(RBₛₜₐᵣₜ, 2)=0, may indicate the use of the first configured extension factor (dark gray). RIVs resulting in odd RB_start within the zone (430 to 440) may use the second extension (white). Thus, the gNB may indicate the used extension value by minor shift of RB_start (410).

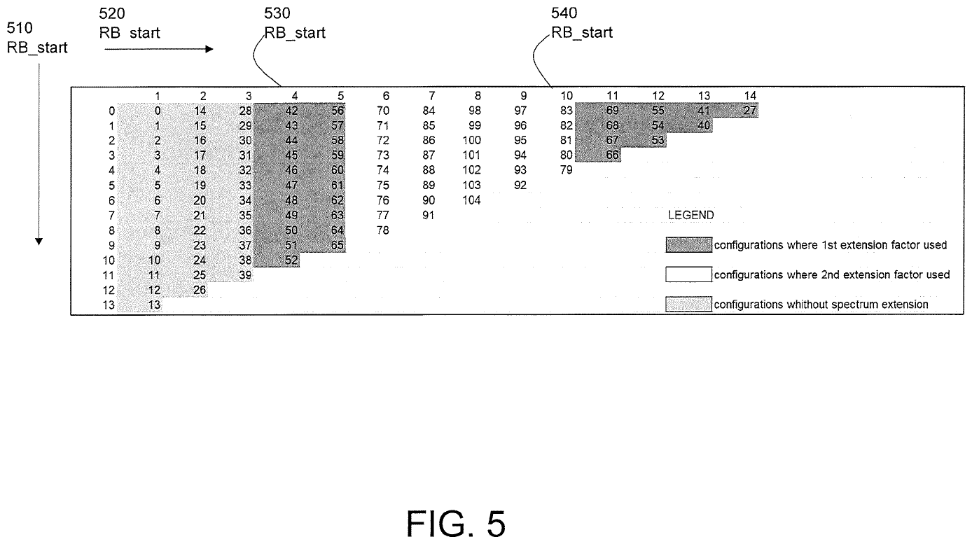

Referring now to FIG. 5, illustrated is an example of RIV-based extension factor determination based on RIV thresholds. In the example of FIG. 5, RIV may be used as an implicit indicator; the configuration provided by the UE is depicted using a table for illustrative purposes. In the present example, the BWP size is 14. The first column (510) shows starting PRB. The first row (520) shows allocation size (note that allocations not applicable to DFT-s-OFDM are included for simplicity, even though they are not to be considered in practice. This does not change the principle illustrated in the table.). One allocation zone to apply multiple extension factor values based on the rules is configured, and its boundaries are set as L_RBmin=4 (530), L_RBmax=10 (540). The light gray area is mapped to configurations without spectrum extension. The dark gray area is mapped to configurations where the first extension factor is used. The white area is mapped to configurations where the second extension factor is used. RIVs larger than a threshold (69) may use the second extension (white). RIVs smaller or equal to the threshold may use the first extension (dark gray). Thus, based on RIV value, the extension size may be implicitly indicated; the extension factor may be dependent on allocation size.

In an example embodiment, it may optionally be assumed that the case without an extension factor may be configured/indicated by the NW (i.e., the grey area). Examples without the possibility of configuring/indicating a transmission without spectrum extension (i.e., no light gray zone) may be devised following the same principles; in other words, as many colors may be used as there are number of configured extension factors used (plus one, i.e., the without spectrum extension case).

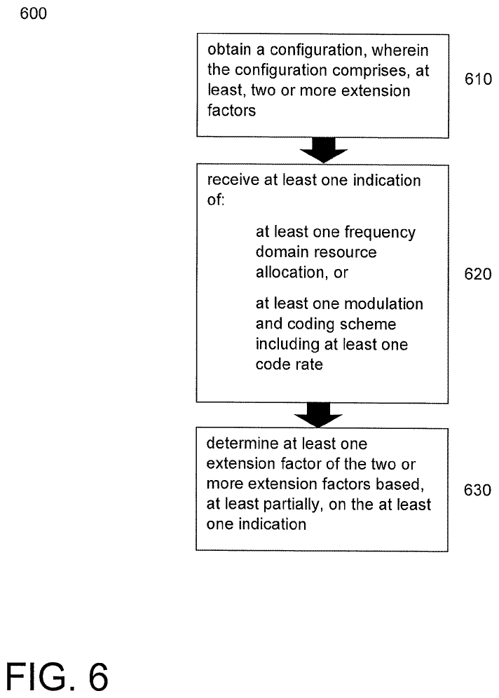

FIG. 6 illustrates the potential steps of an example method 600. The example method 600 may include: obtaining a configuration, wherein the configuration comprises, at least, two or more extension factors, 610; receiving at least one indication of: at least one frequency domain resource allocation, or at least one modulation and coding scheme including at least one code rate, 620; and determining at least one extension factor of the two or more extension factors based, at least partially, on the at least one indication, 630. The example method 600 may be performed, for example, with a UE. The “at least one extension factor” may include a first or a second extension factor, or the like.

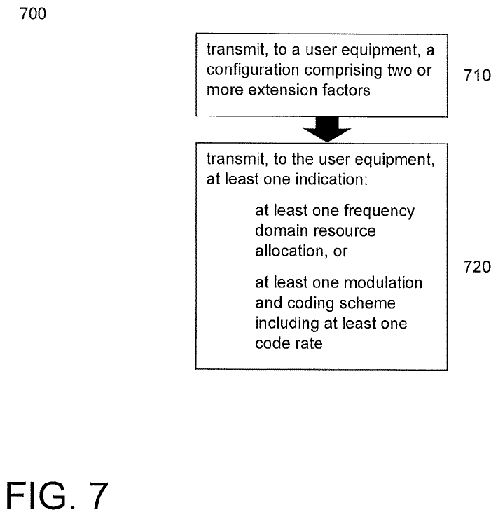

FIG. 7 illustrates the potential steps of an example method 700. The example method 700 may include: transmitting, to a user equipment, a configuration comprising two or more extension factors, 710; and transmitting, to the user equipment, at least one indication of: at least one frequency domain resource allocation, or at least one modulation and coding scheme including at least one code rate, 720. The example method 700 may be performed, for example, with a base station, gNB, network node, etc.

In accordance with one example embodiment, an apparatus may comprise: at least one processor; and at least one memory storing instructions that, when executed by the at least one processor, cause the apparatus at least to: obtain a configuration, wherein the configuration may comprise, at least, two or more extension factors; receive at least one indication of: at least one frequency domain resource allocation, or at least one modulation and coding scheme including at least one code rate; and determine at least one extension factor of the two or more extension factors based, at least partially, on the at least one indication.

The example apparatus may be further configured to: receive a scheduling downlink control information, wherein the scheduling downlink control information may comprise, at least, the at least one indication.

The configuration may be obtained via radio resource control signaling.

The two or more extension factors may comprise, at least, a default extension factor.

The two or more extension factors may comprise, at least, an extension factor of zero, wherein the extension factor of zero may be configured to indicate that spectrum extension is not to be applied.

The at least one indication may further comprise an indication of whether an extension factor is to be applied.

The determining the at least one extension factor of the two or more extension factors may comprise the example apparatus being further configured to: determine the at least one extension factor based, at least partially, on at least one of: an indication of whether extension is applicable for a physical uplink shared channel message, a resource indication value, a size of a bandwidth part for the physical uplink shared channel message, an allocation size for the physical uplink shared channel message, a starting resource block within the bandwidth part for the physical uplink shared channel message, an indication of one or more ranges of an allocation size within the bandwidth part for the physical uplink shared channel message, an indication of one or more ranges of the at least one code rate, or a maximum code rate.

A first extension factor of the two or more extension factors may be associated with a first spectrum flatness requirement, wherein a second extension factor of the two or more extension factors may be associated with a second spectrum flatness requirement, wherein the first extension factor may be at least partially different from the second extension factor, wherein the first spectrum flatness requirement may be at least partially different from the second spectrum flatness requirement.

The at least one extension factor may be determined based, at least partially, on an allocation size within a bandwidth part for a physical uplink shared channel message.

The at least one extension factor may be determined based, at least partially, on one of: a determination that a resource indication value corresponds to an even starting resource block of a bandwidth part for a physical uplink shared channel message, a determination that the resource indication value corresponds to an odd starting resource block of the bandwidth part for the physical shared channel message, or a determination that the resource indication value is odd or even.

The at least one extension factor may be determined based, at least partially, on a determination that the at least one extension factor corresponds to: a difference between a starting resource block, corresponding to the resource indication value, and a number of extension factors of the two or more extension factors, plus one, wherein the two or more extension factors are numbered starting with one.

The at least one extension factor may be determined based, at least partially, on a determination that the at least one extension factor corresponds to: a difference between a starting resource block, corresponding to the resource indication value, and a number of extension factors of the two or more extension factors, wherein the two or more extension factors are numbered starting with zero.

The at least one extension factor may be determined based, at least partially, on a resource indication value, wherein the resource indication value may correspond to an allocation region within a bandwidth part for a physical uplink shared channel message, wherein the allocation region may correspond to the at least one determined extension factor.

The at least one extension factor may be determined based, at least partially, on the at least one code rate, wherein the at least one code rate may correspond to a range of code rate, wherein the range of code rate may correspond to the at least one determined extension factor.

A first extension factor of the two or more extension factors may be associated with a first allocation region within a bandwidth part for a physical uplink shared channel message, wherein a second extension factor of the two or more extension factors may be associated with a second allocation region within the bandwidth part for the physical uplink shared channel message, wherein the first extension factor may be at least partially different from the second extension factor, wherein the first allocation region may be at least partially different from the second allocation region.

The at least one extension factor may be determined based, at least partially, on at least one allocation size threshold, wherein a first extension factor of the two or more extension factors may be associated with an allocation size greater than the at least one allocation size threshold, wherein a second extension factor of the two or more extension factors may be associated with an allocation size less than the at least one allocation size threshold.

A first extension factor of the two or more extension factors may be determined to result in a physical resource block allocation outside a current bandwidth part, wherein the at least one determined extension factor may comprise a second extension factor of the two or more extension factors based, at least partially, on a determination that the second extension factor is smaller than the first extension factor.

The example apparatus may be further configured to: truncate the at least one determined extension factor based, at least partially, on a determination that the at least one determined extension factor results in a physical resource block allocation with at least one physical resource block outside a current bandwidth part.

The example apparatus may be further configured to: apply the at least one determined extension factor for a physical uplink shared channel message.

The example apparatus may be further configured to: transmit the physical uplink shared channel message.

The example apparatus may be further configured to: receive at least one message based, at least partially, on the at least one determined extension factor.

The at least one determined extension factor may indicate that spectrum extension is not to be applied.

In accordance with one aspect, an example method may be provided comprising: obtaining, with a user equipment, a configuration, wherein the configuration may comprise, at least, two or more extension factors; receiving at least one indication of: at least one frequency domain resource allocation, or at least one modulation and coding scheme including at least one code rate; and determining at least one extension factor of the two or more extension factors based, at least partially, on the at least one indication.

The example method may further comprise: receiving a scheduling downlink control information, wherein the scheduling downlink control information may comprise, at least, the at least one indication.

The configuration may be obtained via radio resource control signaling.

The two or more extension factors may comprise, at least, a default extension factor.

The two or more extension factors may comprise, at least, an extension factor of zero, wherein the extension factor of zero may be configured to indicate that spectrum extension is not to be applied.

The at least one indication may further comprise an indication of whether an extension factor is to be applied.

The determining of the at least one extension factor of the two or more extension factors may comprise: determining the at least one extension factor based, at least partially, on at least one of: an indication of whether extension is applicable for a physical uplink shared channel message, a resource indication value, a size of a bandwidth part for the physical uplink shared channel message, an allocation size for the physical uplink shared channel message, a starting resource block within the bandwidth part for the physical uplink shared channel message, an indication of one or more ranges of an allocation size within the bandwidth part for the physical uplink shared channel message, an indication of one or more ranges of the at least one code rate, or a maximum code rate.

A first extension factor of the two or more extension factors may be associated with a first spectrum flatness requirement, wherein a second extension factor of the two or more extension factors may be associated with a second spectrum flatness requirement, wherein the first extension factor may be at least partially different from the second extension factor, wherein the first spectrum flatness requirement may be at least partially different from the second spectrum flatness requirement.

The at least one extension factor may be determined based, at least partially, on an allocation size within a bandwidth part for a physical uplink shared channel message.

The at least one extension factor may be determined based, at least partially, on one of: a determination that a resource indication value corresponds to an even starting resource block of a bandwidth part for a physical uplink shared channel message, a determination that the resource indication value corresponds to an odd starting resource block of the bandwidth part for the physical shared channel message, or a determination that the resource indication value is odd or even.

The at least one extension factor may be determined based, at least partially, on a determination that the at least one extension factor corresponds to: a difference between a starting resource block, corresponding to the resource indication value, and a number of extension factors of the two or more extension factors, plus one, wherein the two or more extension factors are numbered starting with one.

The at least one extension factor may be determined based, at least partially, on a determination that the at least one extension factor corresponds to: a difference between a starting resource block, corresponding to the resource indication value, and a number of extension factors of the two or more extension factors, wherein the two or more extension factors are numbered starting with zero.

The at least one extension factor may be determined based, at least partially, on a resource indication value, wherein the resource indication value may correspond to an allocation region within a bandwidth part for a physical uplink shared channel message, wherein the allocation region may correspond to the at least one determined extension factor.

The at least one extension factor may be determined based, at least partially, on the at least one code rate, wherein the at least one code rate may correspond to a range of code rate, wherein the range of code rate may correspond to the at least one determined extension factor.

A first extension factor of the two or more extension factors may be associated with a first allocation region within a bandwidth part for a physical uplink shared channel message, wherein a second extension factor of the two or more extension factors may be associated with a second allocation region within the bandwidth part for the physical uplink shared channel message, wherein the first extension factor may be at least partially different from the second extension factor, wherein the first allocation region may be at least partially different from the second allocation region.

The at least one extension factor may be determined based, at least partially, on at least one allocation size threshold, wherein a first extension factor of the two or more extension factors may be associated with an allocation size greater than the at least one allocation size threshold, wherein a second extension factor of the two or more extension factors may be associated with an allocation size less than the at least one allocation size threshold.

A first extension factor of the two or more extension factors may be determined to result in a physical resource block allocation outside a current bandwidth part, wherein the at least one determined extension factor may comprise a second extension factor of the two or more extension factors based, at least partially, on a determination that the second extension factor is smaller than the first extension factor.

The example method may further comprise: truncating the at least one determined extension factor based, at least partially, on a determination that the at least one determined extension factor results in a physical resource block allocation with at least one physical resource block outside a current bandwidth part.

The example method may further comprise: applying the at least one determined extension factor for a physical uplink shared channel message.

The example method may further comprise: transmitting the physical uplink shared channel message.

The example method may further comprise: receiving at least one message based, at least partially, on the at least one determined extension factor.

The at least one determined extension factor may indicate that spectrum extension is not to be applied.

In accordance with one example embodiment, an apparatus may comprise: circuitry configured to perform: obtaining, with a user equipment, a configuration, wherein the configuration may comprise, at least, two or more extension factors; circuitry configured to perform: receiving at least one indication of: at least one frequency domain resource allocation, or at least one modulation and coding scheme including at least one code rate; and circuitry configured to perform: determining at least one extension factor of the two or more extension factors based, at least partially, on the at least one indication.

In accordance with one example embodiment, an apparatus may comprise: processing circuitry; memory circuitry including computer program code, the memory circuitry and the computer program code configured to, with the processing circuitry, enable the apparatus to: obtain a configuration, wherein the configuration may comprise, at least, two or more extension factors; receive at least one indication of: at least one frequency domain resource allocation, or at least one modulation and coding scheme including at least one code rate; and determine at least one extension factor of the two or more extension factors based, at least partially, on the at least one indication.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: obtaining a configuration, wherein the configuration may comprise, at least, two or more extension factors; receiving at least one indication of: at least one frequency domain resource allocation, or at least one modulation and coding scheme including at least one code rate; and determining at least one extension factor of the two or more extension factors based, at least partially, on the at least one indication.

The means may be further configured to perform: receiving a scheduling downlink control information, wherein the scheduling downlink control information may comprise, at least, the at least one indication.

The configuration may be obtained via radio resource control signaling.

The two or more extension factors may comprise, at least, a default extension factor.

The two or more extension factors may comprise, at least, an extension factor of zero, wherein the extension factor of zero may be configured to indicate that spectrum extension is not to be applied.

The at least one indication may further comprise an indication of whether an extension factor is to be applied.

The means configured to perform determining the at least one extension factor of the two or more extension factors may comprise means configured to perform: determining the at least one extension factor based, at least partially, on at least one of: an indication of whether extension is applicable for a physical uplink shared channel message, a resource indication value, a size of a bandwidth part for the physical uplink shared channel message, an allocation size for the physical uplink shared channel message, a starting resource block within the bandwidth part for the physical uplink shared channel message, an indication of one or more ranges of an allocation size within the bandwidth part for the physical uplink shared channel message, an indication of one or more ranges of the at least one code rate, or a maximum code rate.

A first extension factor of the two or more extension factors may be associated with a first spectrum flatness requirement, wherein a second extension factor of the two or more extension factors may be associated with a second spectrum flatness requirement, wherein the first extension factor may be at least partially different from the second extension factor, wherein the first spectrum flatness requirement may be at least partially different from the second spectrum flatness requirement.

The at least one extension factor may be determined based, at least partially, on an allocation size within a bandwidth part for a physical uplink shared channel message.

The at least one extension factor may be determined based, at least partially, on one of: a determination that a resource indication value corresponds to an even starting resource block of a bandwidth part for a physical uplink shared channel message, a determination that the resource indication value corresponds to an odd starting resource block of the bandwidth part for the physical shared channel message, or a determination that the resource indication value is odd or even.

The at least one extension factor may be determined based, at least partially, on a determination that the at least one extension factor corresponds to: a difference between a starting resource block, corresponding to the resource indication value, and a number of extension factors of the two or more extension factors, plus one, wherein the two or more extension factors are numbered starting with one.

The at least one extension factor may be determined based, at least partially, on a determination that the at least one extension factor corresponds to: a difference between a starting resource block, corresponding to the resource indication value, and a number of extension factors of the two or more extension factors, wherein the two or more extension factors are numbered starting with zero.

The at least one extension factor may be determined based, at least partially, on a resource indication value, wherein the resource indication value may correspond to an allocation region within a bandwidth part for a physical uplink shared channel message, wherein the allocation region may correspond to the at least one determined extension factor.

The at least one extension factor may be determined based, at least partially, on the at least one code rate, wherein the at least one code rate may correspond to a range of code rate, wherein the range of code rate may correspond to the at least one determined extension factor.

A first extension factor of the two or more extension factors may be associated with a first allocation region within a bandwidth part for a physical uplink shared channel message, wherein a second extension factor of the two or more extension factors may be associated with a second allocation region within the bandwidth part for the physical uplink shared channel message, wherein the first extension factor may be at least partially different from the second extension factor, wherein the first allocation region may be at least partially different from the second allocation region.

The at least one extension factor may be determined based, at least partially, on at least one allocation size threshold, wherein a first extension factor of the two or more extension factors may be associated with an allocation size greater than the at least one allocation size threshold, wherein a second extension factor of the two or more extension factors may be associated with an allocation size less than the at least one allocation size threshold.

A first extension factor of the two or more extension factors may be determined to result in a physical resource block allocation outside a current bandwidth part, wherein the at least one determined extension factor may comprise a second extension factor of the two or more extension factors based, at least partially, on a determination that the second extension factor is smaller than the first extension factor.

The means may be further configured to perform: truncating the at least one determined extension factor based, at least partially, on a determination that the at least one determined extension factor results in a physical resource block allocation with at least one physical resource block outside a current bandwidth part.

The means may be further configured to perform: applying the at least one determined extension factor for a physical uplink shared channel message.

The means may be further configured to perform: transmitting the physical uplink shared channel message.

The means may be further configured to perform: receiving at least one message based, at least partially, on the at least one determined extension factor.

The at least one determined extension factor may indicate that spectrum extension is not to be applied.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause obtaining of a configuration, wherein the configuration may comprise, at least, two or more extension factors; cause receiving of at least one indication of: at least one frequency domain resource allocation, or at least one modulation and coding scheme including at least one code rate; and determine at least one extension factor of the two or more extension factors based, at least partially, on the at least one indication.

In accordance with one example embodiment, a non-transitory computer-readable medium comprising program instructions stored thereon for performing at least the following: causing obtaining of a configuration, wherein the configuration may comprise, at least, two or more extension factors; causing receiving of at least one indication of: at least one frequency domain resource allocation, or at least one modulation and coding scheme including at least one code rate; and determining at least one extension factor of the two or more extension factors based, at least partially, on the at least one indication.

In accordance with another example embodiment, a non-transitory program storage device readable by a machine may be provided, tangibly embodying instructions executable by the machine for performing operations, the operations comprising: causing obtaining of a configuration, wherein the configuration may comprise, at least, two or more extension factors; causing receiving of at least one indication of: at least one frequency domain resource allocation, or at least one modulation and coding scheme including at least one code rate; and determining at least one extension factor of the two or more extension factors based, at least partially, on the at least one indication.

In accordance with another example embodiment, a non-transitory computer-readable medium comprising instructions that, when executed by an apparatus, cause the apparatus to perform at least the following: causing obtaining of a configuration, wherein the configuration may comprise, at least, two or more extension factors; causing receiving of at least one indication of: at least one frequency domain resource allocation, or at least one modulation and coding scheme including at least one code rate; and determining at least one extension factor of the two or more extension factors based, at least partially, on the at least one indication.

A computer implemented system comprising: at least one processor and at least one non-transitory memory storing instructions that, when executed by the at least one processor, cause the system at least to perform: causing obtaining of a configuration, wherein the configuration may comprise, at least, two or more extension factors; causing receiving of at least one indication of: at least one frequency domain resource allocation, or at least one modulation and coding scheme including at least one code rate; and determining at least one extension factor of the two or more extension factors based, at least partially, on the at least one indication.

A computer implemented system comprising: means for causing obtaining of a configuration, wherein the configuration may comprise, at least, two or more extension factors; means for causing receiving of at least one indication of: at least one frequency domain resource allocation, or at least one modulation and coding scheme including at least one code rate; and means for determining at least one extension factor of the two or more extension factors based, at least partially, on the at least one indication.

In accordance with one example embodiment, an apparatus may comprise: at least one processor; and at least one memory storing instructions that, when executed by the at least one processor, cause the apparatus at least to: transmit, to a user equipment, a configuration comprising two or more extension factors; and transmit, to the user equipment, at least one indication of: at least one frequency domain resource allocation, or at least one modulation and coding scheme including at least one code rate.

The example apparatus may be further configured to: transmit, to the user equipment, a scheduling downlink control information, wherein the scheduling downlink control information may comprise, at least, the at least one indication.

The configuration may be transmitted via radio resource control signaling.

The two or more extension factors may comprise, at least, a default extension factor.

The two or more extension factors may comprise, at least, an extension factor of zero, wherein the extension factor of zero may be configured to indicate that spectrum extension is not to be applied.

The at least one indication may further comprise an indication of whether an extension factor is to be applied.

The example apparatus may be further configured to: transmit, to the user equipment, an indication of at least one of: whether extension is applicable for a physical uplink shared channel message, a resource indication value, a size of a bandwidth part for the physical uplink shared channel message, an allocation size for the physical uplink shared channel message, a starting resource block within the bandwidth part for the physical uplink shared channel message, an indication of one or more ranges of an allocation size within the bandwidth part for the physical uplink shared channel message, an indication of one or more ranges of the at least one code rate, or a maximum code rate.

The example apparatus may be further configured to: determine the two or more extension factors.

In response to the two or more extension factors used at the user equipment, wherein a first extension factor of the two or more extension factors may be associated with a first spectrum flatness requirement, wherein a second extension factor of the two or more extension factors may be associated with a second spectrum flatness requirement, wherein the first extension factor may be at least partially different from the second extension factor, wherein the first spectrum flatness requirement may be at least partially different from the second spectrum flatness requirement.

Tn response to the two or more extension factors used at the user equipment, wherein a first extension factor of the two or more extension factors may be associated with a resource indication value that corresponds to an even starting resource block of a bandwidth part for a physical uplink shared channel message, wherein a second extension factor of the two or more extension factors may be associated with a resource indication value that corresponds to an odd starting resource block of a bandwidth part for a physical uplink shared channel message.

A first extension factor of the two or more extension factors used at the user equipment may be associated with a difference between a starting resource block, corresponding to a resource indication value, and a number of extension factors of the two or more extension factors, plus one, wherein the two or more extension factors are numbered starting with one.

A first extension factor of the two or more extension factors may be associated with a difference between a starting resource block, corresponding to a resource indication value, and a number of extension factors of the two or more extension factors, wherein the two or more extension factors are numbered starting with zero.

A first extension factor of the two or more extension factors may be associated with a resource indication value, wherein the resource indication value may correspond to an allocation region within a bandwidth part for a physical uplink shared channel message.

A first extension factor of the two or more extension factors may be associated with a first allocation region within a bandwidth part for a physical uplink shared channel message, wherein a second extension factor of the two or more extension factors may be associated with a second allocation region within the bandwidth part for the physical uplink shared channel message, wherein the first extension factor may be at least partially different from the second extension factor, wherein the first allocation region may be at least partially different from the second allocation region.

A first extension factor of the two or more extension factors may be associated with an allocation size greater than at least one allocation size threshold, wherein a second extension factor of the two or more extension factors may be associated with an allocation size less than the at least one allocation size threshold.

A first extension factor of the two or more extension factors may indicate that spectrum extension is not to be applied.

In accordance with one aspect, an example method may be provided comprising: transmitting, with a network node to a user equipment, a configuration comprising two or more extension factors; and transmitting, to the user equipment, at least one indication of: at least one frequency domain resource allocation, or at least one modulation and coding scheme including at least one code rate.

The example method may further comprise: transmitting, to the user equipment, a scheduling downlink control information, wherein the scheduling downlink control information may comprise, at least, the at least one indication.

The configuration may be transmitted via radio resource control signaling.

The two or more extension factors may comprise, at least, a default extension factor.

The two or more extension factors may comprise, at least, an extension factor of zero, wherein the extension factor of zero may be configured to indicate that spectrum extension is not to be applied.

The at least one indication may further comprise an indication of whether an extension factor is to be applied.

The example method may further comprise: transmitting, to the user equipment, an indication of at least one of: whether extension is applicable for a physical uplink shared channel message, a resource indication value, a size of a bandwidth part for the physical uplink shared channel message, an allocation size for the physical uplink shared channel message, a starting resource block within the bandwidth part for the physical uplink shared channel message, an indication of one or more ranges of an allocation size within the bandwidth part for the physical uplink shared channel message, an indication of one or more ranges of the at least one code rate, or a maximum code rate.

The example method may further comprise: determining the two or more extension factors.

In response to the two or more extension factors used at the user equipment, wherein a first extension factor of the two or more extension factors may be associated with a first spectrum flatness requirement, wherein a second extension factor of the two or more extension factors may be associated with a second spectrum flatness requirement, wherein the first extension factor may be at least partially different from the second extension factor, wherein the first spectrum flatness requirement may be at least partially different from the second spectrum flatness requirement.

In response to the two or more extension factors used at the user equipment, wherein a first extension factor of the two or more extension factors may be associated with a resource indication value that corresponds to an even starting resource block of a bandwidth part for a physical uplink shared channel message, wherein a second extension factor of the two or more extension factors may be associated with a resource indication value that corresponds to an odd starting resource block of a bandwidth part for a physical uplink shared channel message.

A first extension factor of the two or more extension factors used at the user equipment may be associated with a difference between a starting resource block, corresponding to a resource indication value, and a number of extension factors of the two or more extension factors, plus one, wherein the two or more extension factors are numbered starting with one.

A first extension factor of the two or more extension factors may be associated with a difference between a starting resource block, corresponding to a resource indication value, and a number of extension factors of the two or more extension factors, wherein the two or more extension factors are numbered starting with zero.

A first extension factor of the two or more extension factors may be associated with a resource indication value, wherein the resource indication value may correspond to an allocation region within a bandwidth part for a physical uplink shared channel message.

A first extension factor of the two or more extension factors may be associated with a first allocation region within a bandwidth part for a physical uplink shared channel message, wherein a second extension factor of the two or more extension factors may be associated with a second allocation region within the bandwidth part for the physical uplink shared channel message, wherein the first extension factor may be at least partially different from the second extension factor, wherein the first allocation region may be at least partially different from the second allocation region.

A first extension factor of the two or more extension factors may be associated with an allocation size greater than at least one allocation size threshold, wherein a second extension factor of the two or more extension factors may be associated with an allocation size less than the at least one allocation size threshold.

A first extension factor of the two or more extension factors may indicate that spectrum extension is not to be applied.

In accordance with one example embodiment, an apparatus may comprise: circuitry configured to perform: transmitting, to a user equipment, a configuration comprising two or more extension factors; and circuitry configured to perform: transmitting, to the user equipment, at least one indication of: at least one frequency domain resource allocation, or at least one modulation and coding scheme including at least one code rate.

In accordance with one example embodiment, an apparatus may comprise: processing circuitry; memory circuitry including computer program code, the memory circuitry and the computer program code configured to, with the processing circuitry, enable the apparatus to: transmit, to a user equipment, a configuration comprising two or more extension factors; and transmit, to the user equipment, at least one indication of: at least one frequency domain resource allocation, or at least one modulation and coding scheme including at least one code rate.

In accordance with one example embodiment, an apparatus may comprise means for performing: transmitting, to a user equipment, a configuration comprising two or more extension factors; and transmitting, to the user equipment, at least one indication of: at least one frequency domain resource allocation, or at least one modulation and coding scheme including at least one code rate.

The means may be further configured to perform: transmitting, to the user equipment, a scheduling downlink control information, wherein the scheduling downlink control information may comprise, at least, the at least one indication.

The configuration may be transmitted via radio resource control signaling.

The two or more extension factors may comprise, at least, a default extension factor.

The two or more extension factors may comprise, at least, an extension factor of zero, wherein the extension factor of zero may be configured to indicate that spectrum extension is not to be applied.

The at least one indication may further comprise an indication of whether an extension factor is to be applied.

The means may be further configured to perform: transmitting, to the user equipment, an indication of at least one of: whether extension is applicable for a physical uplink shared channel message, a resource indication value, a size of a bandwidth part for the physical uplink shared channel message, an allocation size for the physical uplink shared channel message, a starting resource block within the bandwidth part for the physical uplink shared channel message, an indication of one or more ranges of an allocation size within the bandwidth part for the physical uplink shared channel message, an indication of one or more ranges of the at least one code rate, or a maximum code rate.

The means may be further configured to perform: determining the two or more extension factors.

In response to the two or more extension factors used at the user equipment, wherein a first extension factor of the two or more extension factors may be associated with a first spectrum flatness requirement, wherein a second extension factor of the two or more extension factors may be associated with a second spectrum flatness requirement, wherein the first extension factor may be at least partially different from the second extension factor, wherein the first spectrum flatness requirement may be at least partially different from the second spectrum flatness requirement.

In response to the two or more extension factors used at the user equipment, wherein a first extension factor of the two or more extension factors may be associated with a resource indication value that corresponds to an even starting resource block of a bandwidth part for a physical uplink shared channel message, wherein a second extension factor of the two or more extension factors may be associated with a resource indication value that corresponds to an odd starting resource block of a bandwidth part for a physical uplink shared channel message.

A first extension factor of the two or more extension factors used at the user equipment may be associated with a difference between a starting resource block, corresponding to a resource indication value, and a number of extension factors of the two or more extension factors, plus one, wherein the two or more extension factors are numbered starting with one.

A first extension factor of the two or more extension factors may be associated with a difference between a starting resource block, corresponding to a resource indication value, and a number of extension factors of the two or more extension factors, wherein the two or more extension factors are numbered starting with zero.

A first extension factor of the two or more extension factors may be associated with a resource indication value, wherein the resource indication value may correspond to an allocation region within a bandwidth part for a physical uplink shared channel message.

A first extension factor of the two or more extension factors may be associated with a first allocation region within a bandwidth part for a physical uplink shared channel message, wherein a second extension factor of the two or more extension factors may be associated with a second allocation region within the bandwidth part for the physical uplink shared channel message, wherein the first extension factor may be at least partially different from the second extension factor, wherein the first allocation region may be at least partially different from the second allocation region.

A first extension factor of the two or more extension factors may be associated with an allocation size greater than at least one allocation size threshold, wherein a second extension factor of the two or more extension factors may be associated with an allocation size less than the at least one allocation size threshold.

A first extension factor of the two or more extension factors may indicate that spectrum extension is not to be applied.

In accordance with one example embodiment, a non-transitory computer-readable medium comprising instructions stored thereon which, when executed with at least one processor, cause the at least one processor to: cause transmitting, to a user equipment, of a configuration comprising two or more extension factors; and cause transmitting, to the user equipment, of at least one indication of: at least one frequency domain resource allocation, or at least one modulation and coding scheme including at least one code rate.

In accordance with one example embodiment, a non-transitory computer-readable medium comprising program instructions stored thereon for performing at least the following: causing transmitting, to a user equipment, of a configuration comprising two or more extension factors; and causing transmitting, to the user equipment, of at least one indication of: at least one frequency domain resource allocation, or at least one modulation and coding scheme including at least one code rate.

In accordance with another example embodiment, a non-transitory program storage device readable by a machine may be provided, tangibly embodying instructions executable by the machine for performing operations, the operations comprising: causing transmitting, to a user equipment, of a configuration comprising two or more extension factors; and causing transmitting, to the user equipment, of at least one indication of: at least one frequency domain resource allocation, or at least one modulation and coding scheme including at least one code rate.

In accordance with another example embodiment, a non-transitory computer-readable medium comprising instructions that, when executed by an apparatus, cause the apparatus to perform at least the following: causing transmitting, to a user equipment, of a configuration comprising two or more extension factors; and causing transmitting, to the user equipment, of at least one indication of: at least one frequency domain resource allocation, or at least one modulation and coding scheme including at least one code rate.

A computer implemented system comprising: at least one processor and at least one non-transitory memory storing instructions that, when executed by the at least one processor, cause the system at least to perform: causing transmitting, to a user equipment, of a configuration comprising two or more extension factors; and causing transmitting, to the user equipment, of at least one indication of: at least one frequency domain resource allocation, or at least one modulation and coding scheme including at least one code rate.

A computer implemented system comprising: means for causing transmitting, to a user equipment, of a configuration comprising two or more extension factors; and means for causing transmitting, to the user equipment, of at least one indication of: at least one frequency domain resource allocation, or at least one modulation and coding scheme including at least one code rate.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1. An apparatus comprising:
at least one processor; and
at least one memory storing instructions that, when executed by the at least one processor, cause the apparatus at least to:
obtain a configuration, wherein the configuration comprises, at least, two or more extension factors;
receive at least one indication of:
at least one frequency domain resource allocation, or
at least one modulation and coding scheme including at least one code rate; and
determine at least one extension factor of the two or more extension factors based, at least partially, on the at least one indication.

2. The apparatus of claim 1, wherein the at least one memory, storing the instructions, when executed by the at least one processor, causes the apparatus to:
receive a scheduling downlink control information, wherein the scheduling downlink control information comprises, at least, the at least one indication.

3. The apparatus of claim 1, wherein the configuration is obtained via radio resource control signaling.

4. The apparatus of claim 1, wherein the two or more extension factors comprise, at least, a default extension factor.

5. The apparatus of claim 1, wherein the two or more extension factors comprise, at least, an extension factor of zero, wherein the extension factor of zero is configured to indicate that spectrum extension is not to be applied.

6. The apparatus of claim 1, wherein the at least one indication further comprises an indication of whether an extension factor is to be applied.

7. The apparatus of claim 1, wherein the determining the at least one extension factor of the two or more extension factors comprises the at least one memory, storing the instructions, when executed by the at least one processor, causes the apparatus to:
determine the at least one extension factor based, at least partially, on at least one of:
an indication of whether extension is applicable for a physical uplink shared channel message,
a resource indication value,
a size of a bandwidth part for the physical uplink shared channel message,
an allocation size for the physical uplink shared channel message,
a starting resource block within the bandwidth part for the physical uplink shared channel message,
an indication of one or more ranges of an allocation size within the bandwidth part for the physical uplink shared channel message,
an indication of one or more ranges of the at least one code rate, or
a maximum code rate.

8. The apparatus of claim 1, wherein a first extension factor of the two or more extension factors is associated with a first spectrum flatness requirement, wherein a second extension factor of the two or more extension factors is associated with a second spectrum flatness requirement, wherein the first extension factor is at least partially different from the second extension factor, wherein the first spectrum flatness requirement is at least partially different from the second spectrum flatness requirement.

9. The apparatus of claim 1, wherein the at least one extension factor is determined based, at least partially, on an allocation size within a bandwidth part for a physical uplink shared channel message.

10. The apparatus of claim 1, wherein the at least one extension factor is determined based, at least partially, on one of:
a determination that a resource indication value corresponds to an even starting resource block of a bandwidth part for a physical uplink shared channel message,
a determination that the resource indication value corresponds to an odd starting resource block of the bandwidth part for the physical shared channel message, or
a determination that the resource indication value is odd or even.

11. The apparatus of claim 1, wherein the at least one extension factor is determined based, at least partially, on a determination that the at least one extension factor corresponds to: a difference between a starting resource block, corresponding to the resource indication value, and a number of extension factors of the two or more extension factors, plus one,
wherein the two or more extension factors are numbered starting with one.

12. The apparatus of claim 1, wherein the at least one extension factor is determined based, at least partially, on a determination that the at least one extension factor corresponds to: a difference between a starting resource block, corresponding to the resource indication value, and a number of extension factors of the two or more extension factors,
wherein the two or more extension factors are numbered starting with zero.

13. The apparatus of claim 1, wherein the at least one extension factor is determined based, at least partially, on a resource indication value, wherein the resource indication value corresponds to an allocation region within a bandwidth part for a physical uplink shared channel message, wherein the allocation region corresponds to the at least one determined extension factor.

14. The apparatus of claim 1, wherein the at least one extension factor is determined based, at least partially, on the at least one code rate, wherein the at least one code rate corresponds to a range of code rate, wherein the range of code rate corresponds to the at least one determined extension factor.

15. The apparatus of claim 1, wherein a first extension factor of the two or more extension factors is associated with a first allocation region within a bandwidth part for a physical uplink shared channel message, wherein a second extension factor of the two or more extension factors is associated with a second allocation region within the bandwidth part for the physical uplink shared channel message, wherein the first extension factor is at least partially different from the second extension factor, wherein the first allocation region is at least partially different from the second allocation region.

16. The apparatus of claim 1, wherein the at least one extension factor is determined based, at least partially, on at least one allocation size threshold, wherein a first extension factor of the two or more extension factors is associated with an allocation size greater than the at least one allocation size threshold, wherein a second extension factor of the two or more extension factors is associated with an allocation size less than the at least one allocation size threshold.

17. The apparatus of claim 1, wherein a first extension factor of the two or more extension factors is determined to result in a physical resource block allocation outside a current bandwidth part, wherein the at least one determined extension factor comprises a second extension factor of the two or more extension factors based, at least partially, on a determination that the second extension factor is smaller than the first extension factor.

18. The apparatus of claim 1, wherein the at least one memory, storing the instructions, when executed by the at least one processor, causes the apparatus to:
truncate the at least one determined extension factor based, at least partially, on a determination that the at least one determined extension factor results in a physical resource block allocation with at least one physical resource block outside a current bandwidth part.

19-22. (canceled)

23. A method comprising:
obtaining, with a user equipment, a configuration, wherein the configuration comprises, at least, two or more extension factors;
receiving at least one indication of:
at least one frequency domain resource allocation, or
at least one modulation and coding scheme including at least one code rate; and
determining at least one extension factor of the two or more extension factors based, at least partially, on the at least one indication.

24-25. (canceled)

26. An apparatus comprising:
at least one processor; and
at least one memory storing instructions that, when executed by the at least one processor, cause the apparatus at least to:
transmit, to a user equipment, a configuration comprising two or more extension factors; and
transmit, to the user equipment, at least one indication of:
at least one frequency domain resource allocation, or
at least one modulation and coding scheme including at least one code rate.

27-44. (canceled)
